(19) United States
(12) Patent Application Publication
(10) Pub. No.: US 2008/0000647 A1
(43) Pub. Date: Jan. 3, 2008

(54) Non-Ferrous Metal Cover Gases

(75) Inventors: Matthew H. Luly, Hamburg, NY (US); Rajiv R. Singh, Getzville, NY (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/691,296

(22) Filed: Mar. 26, 2007

Related U.S. Application Data
(60) Provisional application No. 60/818,416, filed on Jul. 3, 2006.

(51) Int. Cl. A62C 3/06; C09K 21/10; C22B 21/00; C22B 26/00

(52) U.S. Cl. 169/46; 252/605; 420/400; 420/402; 420/528; 75/602; 75/680; 75/745

(57) ABSTRACT

Disclosed are cover gas compositions comprising at least one pentafluoropropane for impeding the oxidation of molten nonferrous metals and alloys, such as magnesium.

### CROSS REFERENCE TO RELATED APPLICATION

This application claims the priority of U.S. Provisional Application 60/818,416, filed on Jul. 3, 2006. The contents of this provisional application are incorporated herein by reference.

### BACKGROUND OF THE INVENTION

(1) Field of Invention

The present invention relates to cover gas compositions for molten nonferrous metal, such as magnesium, and methods of using the same to prevent the oxidation when the metal is exposed to air.

(2) Description of Related Art

Certain non-ferrous metals, such as magnesium, aluminum, and lithium, are highly reactive and oxidatively unstable. For example, molten magnesium is readily and violently oxidized in ambient air or dry air, burning with a flame temperature of approximately 2820° C. Three approaches have been suggested to inhibit these severe oxidation processes: (1) sprinkling salt cover fluxes over the molten metal; (2) excluding oxygen from contacting the molten metal by blanketing the molten metal with an inert gas such as helium, nitrogen or argon; or (3) blanketing the molten metal with a protective cover gas composition. Protective cover gas compositions typically comprise air and/or carbon dioxide and a small amount of an inhibiting agent which reacts or interacts with the molten metal to form a film or layer on the molten metal surface which protects it from oxidation.

U.S. Pat. No. 1,972,317 (Reimers) relates to methods for inhibiting the oxidation of readily oxidizable metals, including magnesium and its alloys. Reimers notes that at the time of its filing in 1932, numerous solutions had been proposed to the oxidation problem including displacing the atmosphere in contact with the metal with a gas such as nitrogen, carbon dioxide, or sulfur dioxide. Reimers teaches inhibition of oxidation by maintaining in the atmosphere in contact with molten metal an inhibiting gas containing fluorine, either in elemental or combined form. Reference is made to many fluorine containing compounds with the solids ammonium borofluoride, ammonium silicofluoride, ammonium bifluoride and ammonium fluophosphate or the gases evolved therefrom upon heating being said to be preferred. Notwithstanding the disclosure in Reimers, it was not until about the mid-1970's that a fluorine containing compound found commercial acceptance as an inhibiting agent in a cover gas.

Prior to about the mid-1970's, sulfur dioxide (SO₂) was widely used as an inhibiting agent in a magnesium cover gas composition. However, SO₂ was subsequently replaced by sulfurhexafluoride (SF₆) which is currently the industry standard. Typically, SF₆ based cover gas compositions contain 0.2-1% by volume SF₆ and a carrier gas such as air, carbon dioxide, argon, or nitrogen. SF₆ has the advantages that it is a colorless, odorless, non-toxic gas which can be used for protecting molten magnesium/magnesium alloy and in the production of bright and shiny ingots with relatively low dross formation. However, SF₆ suffers from several disadvantages, including: its sulfur-based decomposition products at high temperature are very toxic; it is expensive and has limited sources of supply; and it is a known greenhouse gas having, at a time horizon of 100 years, a Global Warming Potential (GWP) of 23,900 relative to 1 for carbon dioxide.

It is also noted that once magnesium has ignited, the resulting fire cannot be extinguished even with high concentrations of SF₆. The potential byproduct SO, is even worse in this respect as it can accelerate a magnesium fire.

Another cover gas useful for extinguishing a magnesium fire is boron trifluoride (BF₃). However, this material tends to be very expensive and is also very toxic.

The problem of GWP of cover gases has been addressed in WO 00/64614 wherein certain relatively low GWP hydrofluorocarbons and hydrofluoroethers such as difluoromethane (HFC-32), pentafluoroethane (HFC-125), 1,1,1,2-tetrafluoroethane (HFC-134a), difluoroethane (HFC-152a), methoxy-nonafluorobutane (HFE-7100), ethoxy-nonafluorobutane (HFE-7200), and others were disclosed as being useful as blanket gases for protecting molten magnesium and magnesium alloys from oxidation.

Although previously suggested compounds may have certain limited utility as cover gases, alternative cover gas compositions that have the same or superior characteristics including low GWP, short atmospheric lifetime, and low or no toxicity.

### SUMMARY OF THE INVENTION

According to an aspect of the present invention, provided is a composition for impeding the oxidation of molten nonferrous metals, such as magnesium, and alloys, when such metals or alloys are exposed to air, the composition comprising at least one pentafluoropropane, preferably 1,1,1,3,3-pentafluoropropane (HFC-245fa). As used herein, the term “air” means either ambient air, dry air, or moist air. HFC-245fa is well suited for use as a cover gas in view of its relatively low GWP potential, short atmospheric lifetime, and non-toxicity.

In addition, provided is a molten reactive metal having a protective film on its surface that is formed by a reaction between the metal and a pentafluoropropane composition, preferably a HFC-245fa composition. It is believed that HFC-245fa passivates the surface of the metal thereby reducing the chemical reactivity of the metal, especially the metal's oxidative reactivity.

According to another aspect of the present invention, provided is a method for impeding the oxidation of a molten nonferrous metal exposed to air, comprising: (a) providing molten nonferrous metal, such as magnesium, having a surface; (b) exposing said surface to a layer of a gaseous composition comprising a pentafluoropropane, preferably HFC-245fa; and optionally (c) forming an oxidized film on said surface. In this method, the exposed surface of the molten reactive metal is exposed to or contacted with the gaseous HFC-245fa composition. It is believed that the HFC-245fa composition can react with the metal to produce an oxidatively stable film on its surface. By forming this film, the oxygen in the air can be effectively separated from the surface of the molten reactive metal, thus preventing the oxidation of the metal by the oxygen.

According to yet another aspect of the present invention, provided is a method for extinguishing a fire on a surface of a molten nonferrous metal, such as magnesium, comprising contacting said surface with a gaseous composition comprising a pentafluoropropane, preferably HFC-245fa.

### DETAILED DESCRIPTION OF PREFERRED EMBODIMENTS OF THE INVENTION

The cover gas compositions of the present invention are generally effective as cover gases to impede the oxidation of molten reactive metals when the surface of the metal is exposed to source of oxygen, such as air. As used herein, the term “nonferrous reactive metal” means a metal or alloy which is sensitive to destructive, vigorous oxidation when exposed to air, such as magnesium, aluminum, or lithium, or an alloy comprising at least one of these metals. For convenience, the following description of illustrative embodiments of the invention shall refer to magnesium. It is understood, however, that the present invention can also be used with aluminum, lithium, or other nonferrous reactive metal, or an alloy containing at least one of these metals.

Without necessarily being bound by theory, it is believed that by impeding oxidation, the cover gas composition of the present invention is capable of protecting the molten metal from ignition. As is the case with known fluorine-containing cover gases, it is believed that compositions comprising pentafluoropropane, and particularly 1,1,1,3,3-pentafluoropropane, can react with the molten metal surface to create a thin passivation layer or film that can function as a barrier between the metal and an oxygen source. Pentafluoropropanes provide an effective and economical alternative to known fluorine-containing cover gases.

In addition to pentafluoropropane, cover gas compositions of the present invention may include a carrier gas. Preferred carrier gases include, but are not limited to, nitrogen, carbon dioxide, air, and/or noble gas such as argon. Preferably, the composition comprises a minor amount of pentafluoropropane and a major amount of a carrier gas. In certain preferred embodiments, the composition comprises from about 0.01 to about 2 weight percent of a pentafluoropropane and from about 99.99 to about 98 weight percent of a carrier gas.

As used herein, “GWP” is a relative measure of the warming potential of a compound based on the structure of the compound. The concept of GWP was developed to compare the ability of each greenhouse gas to trap heat in the atmosphere relative to another gas. Generally, the GWP for a particular greenhouse gas is the ratio of heat trapped by one unit mass of the greenhouse gas to that of one unit mass of CO₂ over a specified time period. More specifically, the GWP of a compound, as defined by the Intergovernmental Panel on Climate Change (IPCC) in 1990 and updated in Scientific Assessment of Ozone Depletion: 1998 (World Meteorological Organization, Scientific Assessment of Ozone Depletion: 1998, Global Ozone Research and Monitoring Project—Report No. 44, Geneva, 1999), is calculated as the warming due to the release of 1 kilogram of a compound relative to the warming due to the release of 1 kilogram of CO₂ over a specified integration time horizon (ITH):

$${GWP}_{X} ( {t}^{′} ) = \frac{{\int }_{0}^{{t}^{′}} {F}_{X} exp ( - t / {τ}_{X} ) d t}{{\int }_{0}^{{t}^{′}} {F}_{{CO}_{2}} R ( t ) d t}$$

where F is the radiative forcing per unit mass of a compound (the change in the flux of radiation through the atmosphere due to the IR absorbance of that compound), C is the atmospheric concentration of a compound, σ is the atmospheric lifetime of a compound, t is time, and x is the compound of interest.

The commonly accepted ITH is 100 years representing a compromise between short-term effects (20 years) and longer-term effects (500 years or longer). The concentration of an organic compound, x, in the atmosphere is assumed to follow pseudo first order kinetics (i.e., exponential decay). The concentration of CO₂ over that same time interval incorporates a more complex model for the exchange and removal of CO₂ from the atmosphere (the Bern carbon cycle model).

In certain embodiments, cover gas composition, in addition to HFC-245fa, may further comprise one or more fluoroolefins. Preferred fluoroolefin compounds include those having a GWP of less than about 1000, more preferably less that about 150 and even more preferably of less than about 100. In certain preferred embodiments, each component present in the cover gas in a substantial amount has a GWP of less than about 1000, more preferably less that about 150 and even more preferably of less than about 100. In certain highly preferred embodiments, each component of the composition which is present in more than an insubstantial amount has a GWP of less than about 10, and even more preferably less than about 5. For comparison, the GWP of CO₂, certain conventional cover gases, and certain cover gases according to the present invention are shown in Table A.

TABLE A

| | | Atmospheric | Boiling |
|---|---|---|---|
| Compound | GWP (100 Yr) | Lifetime (Yr) | Point (° C.) |
| CO₂ | 1 | 100-150 | −78 |
| SF₆ | 23,900 | 3,200 | −82 |
| NF₃ | 10,800 | 740 | −121 |
| C₂F₆ | 11,400 | 10,000 | −78 |
| HFC-134a | 1600 | 13.6 | −26 |
| HFC-125 | 3400 | 29 | −48.5 |
| HFC-245fa | 950 | 7.6 | 15 |
| HFO-1234yf | 4 | 0.04 | −30 |
| trans-HFO-1234ze | 6 | 0.05 | −18.4 |
| cis-HFO-1234ye | <15 | <0.1 | +2 |
| HFCO-1233xf | <20 | <0.1 | +12 |
| cis-HFCO-1233zd | <20 | <0.1 | +19 |
| trans-HFCO-1233zd | <20 | <0.1 | +19 |

Preferably, the cover gas compositions of the present invention include those compositions wherein each component present in a significant amount has a atmospheric lifetime of less than about 20 (years), more preferably less than about 10 (years). As used herein, the term “atmospheric lifetime” is the approximate amount of time it would take for the concentration of the compound to fall to e⁻¹ of its initial value as a result of either being converted into another chemical compound (wherein e is the base of natural logarithms). Atmospheric lifetime is closely related to GWP since relatively short lifetimes limit the duration that a reactant can participate in a reaction.

Preferably, fluoroolefins used in the present compositions have low or no toxicity. In this regard, it is preferred that components present in the cover gas compositions in more than an insubstantial amount have a LC-50 value of at least about 100,000 ppm, and more preferably at least about 200,000 ppm. As used herein, the term “LC-50 value” means the concentration of the compound in air that will kill 50% of test subject (e.g. mice) when administered as a single exposure (e.g. 4 hours). For example, HFC-245fa has been found to have a 4-hour LC-50 of at least 100,000. For comparison, other known cover gas compounds, such as sulfuryl fluoride, nitrosyl fluoride, and nitrogen trifluoride are known to be toxic and/or hazardous materials.

### EXAMPLES

Certain aspects of the present invention are further illustrated, but is not limited by, the following examples.

Prophetic examples 1-3 demonstrate the potential efficacy of HFC-245fa as a Mg cover gas according to the present invention.

### Example 1

A quartz tube having a well is equipped with a metered source of cover gas and a thermocouple which was placed in the well. The well is filled with about 0.2 to 0.3 g of solid magnesium pieces. The cover gas is a mixture of air (a carrier gas) and HFC-245fa. The air and the HFC-245fa are provided from separate cylinders and the relative amounts of each entering the mixture are controlled to give composition of about 1.0% HFC-245fa by volume.

The tube containing the magnesium is placed in an oven. A flow of cover gas through the tube and over the well containing the magnesium is then established at about 1 liter/minute. The oven is then heated to about 700° C. The flow of cover gas proceeded until a surface film is formed on the magnesium or the magnesium ignited. Deliberate rupturing of the surface film does not induce burning of the molten Mg sample.

After the test is complete, the magnesium is removed from the oven and visually inspected to determine the quality of the cover gas.

The magnesium contains a white coating (presumably MgO or MgF₂) indicating that the magnesium was well protected.

### Example 2

The experiment of Example 1 is repeated, except that the cover gas contained about 0.5% HFC-245fa by volume.

Deliberate rupturing of the surface film does not induce burning of the molten Mg sample. The magnesium contains a white coating (presumably MgO or MgF₂) indicating that the magnesium was well protected.

### Example 3

The experiment of Example 1 is repeated, except that the cover gas contained about 0.05% HFC-245fa by volume.

Deliberate rupturing of the surface film does not induce burning of the molten Mg sample. The magnesium contains a white coating (presumably MgO or MgF₂) indicating that the magnesium was well protected.

### Comparative Examples

The experiments of Examples 1-3 are repeated, except that the cover gas contained SF₆.

The results of the comparative examples are provided in Table B. In general, SF₆, and HFC-245fa performs well as cover gases at concentrations at or above about 1.0% by volume. However, performance of the different cover gases begins to vary at about 0.5% by volume, with HFC-245fa performing better than SF₆. It is believed that the ability of the cover gas to protect the magnesium, and particularly to keep the magnesium from igniting, corresponds to the amount of fluorine it provides to create a protective barrier.

Thus, cover gases that are more reactive, such as HFC-245fa, are better suited to protect magnesium compared to more stable gases, such as SF₆.

TABLE B

| Vol. % of | | |
|---|---|---|
| F-Source | | |
| in Air | F-Source | Quality of Mg Protection |
| 1.0 | SF₆ | white coating; pieces not stuck together |
| 1.0 | HFC-245fa | white coating; pieces not stuck together |
| 0.5 | SF₆ | coating less white; brownish regions; Mg |
| | | maintained partial luster |
| 0.5 | HFC-245fa | white coating with no brown spots |
| 0.05 | SF₆ | failure; Mg ignited |
| 0.05 | HFC-134a | a few brown specks, well protected in general |

Having thus described a few particular embodiments of the invention, various alterations, modifications, and improvements will readily occur to those skilled in the art. Such alterations, modifications, and improvements, as are made obvious by this disclosure, are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A cover gas composition for impeding the oxidation of molten nonferrous metals and alloys when exposed to air, said composition comprising a pentafluoropropane.

2. The cover gas composition of claim 1 wherein said pentafluoropropane is 1,1,1,3,3-pentafluoropropane.

3. The cover gas composition of claim 1 further comprising at least one fluoroolefin.

4. The cover gas composition of claim 1 further comprising a carrier gas selected from the group consisting of nitrogen, carbon dioxide, air, noble gas, and mixtures thereof.

5. The cover gas composition of claim 4 consisting essentially of 1,1,1,3,3-pentafluoropropane and said carrier gas.

6. The cover gas composition of claim 4 comprising from about 98 to about 99.99 weight percent of a carrier gas and from about 0.01 to about 2 weight percent of said 1,1,1,3,3-pentafluoropropane.

7. The cover gas composition of claim 1 wherein said metal is selected from the group consisting of magnesium, aluminum, lithium, and alloys thereof.

8. The cover gas composition of claim 7 wherein said metal is magnesium.

9. A method for impeding the oxidation of a molten nonferrous metal exposed to air, comprising:
(a) providing molten nonferrous metal having a surface; and
(b) exposing said surface to a layer of a gaseous composition comprising at least one pentafluoropropane.

10. The method of claim 9 further comprising the step of:
(c) forming an oxidized film on said surface.

11. The method of claim 9 wherein said pentafluoropropane is 1,1,1,3,3-pentafluoropropane.

12. The method of claim 11 wherein said gaseous composition further comprises at least one fluoroolefin.

13. The method of claim 9 wherein said gaseous composition further comprises a carrier gas selected from the group consisting of nitrogen, carbon dioxide, air, noble gas, and mixtures thereof.

14. The method of claim 13 wherein said gaseous composition consists essentially of 1,1,1,3,3-pentafluoropropane and said carrier gas.

15. The method of claim 9 wherein said metal is selected from the group consisting of magnesium, aluminum, lithium, and alloys thereof.

16. The method of claim 15 wherein said metal is magnesium.

17. A molten metal composition comprising a nonferrous reactive metal having a protective film on its surface, wherein said film is formed by a reaction between the metal and a composition comprising a pentafluoropropane and said film impedes the oxidation of said metal.

18. The molten metal composition of claim 17 wherein said metal is selected from the group consisting of magnesium, aluminum, lithium, and alloys of at least one these.

19. The molten metal composition of claim 18 wherein said metal is magnesium or a magnesium alloy.

20. A method for extinguishing a fire on a surface of a molten nonferrous metal comprising contacting said surface with a gaseous composition comprising pentafluoropropane.
